(19) United States
(12) Patent Application Publication
(10) Pub. No.: US 2006/0196305 A1
(43) Pub. Date: Sep. 7, 2006

(54) Bearing arrangement in a gearbox housing

(76) Inventor: Hagen Dopfert, Lindau (DE)

Correspondence Address: DAVIS & BUJOLD, P.L.L.C., 112 PLEASANT STREET, CONCORD, NH, 03301, US

(21) Appl. No.: 10/523,321

(22) PCT Filed: Aug. 1, 2003
(86) PCT No.: PCT/EP03/08508

§ 371 Date: Feb. 2, 2005

(30) Foreign Application Priority Data
Aug. 7, 2002 (DE) 102 36 089.8

(51) Int. Cl. F16H 35/00

(52) U.S. Cl. 74/640

(57) ABSTRACT

A bearing arrangement in one gearbox housing (1) for at least two successively disposed wheels (2, 3) upon respective independently rotating co-axial shafts (4, 5) of which one has on one end and the other on an opposite end respective bearings (6, 9) each supported in the gearbox housing (1). One additional bearing (14) is provided between the one and the other shaft (4, 5).

The invention relates to a nearing arrangement in a gearbox housing having the features of claim 1.

In gearbox housings 2 successively disposed wheels are supported on respective independently rotating co-axial shafts which conventionally have one bearing in each of both ends and are supported in the gearbox housing. This arrangement has the following disadvantages: between the two shafts one intermediate wall of the housing is needed which results in a complicated design of the gearbox housing; said intermediate wall needs axial installation space; with small axial distance to adjacent shafts, the installation space problem becomes still greater with the intermediate wall, since in that case one intermediate ring becomes, in addition, required for the adjacent shaft; both bearings require between the shafts axial and radial installation space; even if both shafts rotate at equal speed and in the same direction, power losses result on 4 bearings and, in case of taper roller bearings, the two shafts have to be separately adjusted with the consequent assembly expense.

The problem on which the invention is based is to provide in a gearbox housing a simple, economic and space-saving arrangement for at least 2 successively disposed wheels upon respective independently rotating co-axil shafts with reduced power losses and reduced assembly cost.

The solution results with a bearing arrangement in a gearbox housing having the features of claim 1. Advantageous developments of the invention are shown in the sub-claims.

According to the invention, one bearing arrangement in a gearbox housing has at least two successively disposed wheels upon respective independently rotating co-axial shafts having one bearing on each opposite end which is supported in the gearbox housing. At least one other bearing is provided between one and the other shaft for support of the shafts in each other so that an intermediate wall can be omitted in the gearbox housing. The inventive bearing arrangement essentially offers the following advantages: simpler housing design by omission of the intermediate wall; reduction of the axial installation space by omission of the intermediate wall; reduction of the radial installation space by omission between the shafts of bearings of larger diameter than the shafts; reduction of the axial installation space by space-saving bearings between the two shafts; advantage in cost by more economical axial and radial needle gearings between the two shafts; reduction in weight by omission of the intermediate wall and by lighter bearings between the two shafts; power loss only on outer bearings when both shafts rotate at the same speed and in the same direction and when using fixed/loose bearings, such as ball/taper roller bearings, the two shafts can be jointly adjusted at reduced assembly cost.

According to a preferred development of the invention, the additional bearing comprises one radial bearing between one and the other shaft for absorbing radial forces.

According to another preferred development of the invention, the additional bearing comprises one other radial bearing for absorbing radial forces so that the radial forces for a bending load of the two shafts are leveled off and one axial bearing diverts the axial forces between one and the other shaft.

According to one other preferred development of the invention, the additional bearing comprises one tape roller bearing between one and the other shaft which can absorb both radial and axial forces.

According to one preferred development of the invention, the bearing arrangement in a gearbox housing has at least two successively disposed wheels upon respective independently rotating co-axial shafts of which one on both ends and the other on one end have on each one fixed/loose bearing, such as ball/taper roller bearings, which are supported in the gearbox housing. At least one other bearing is provided between one and the other shaft. The inventive bearing arrangement essentially offers the following advantages: reduction of the axial installation space since the intermediate wall accommodates only one bearing; and power losses only on three outer bearings when both shafts rotate at equal speed and in the same direction instead of power losses on four outer bearings.

According to one other preferred development of the invention, the gearbox housing comprises one adjustably mounted spur gear drive cover. One of the bearings of the independently rotating co-axial shafts is mounted in the spur gear drive cover and the other bearing in the gearbox housing. With the one-sided bearing arrangement in the spur gear drive cover adjustable to the gearbox housing, the alignment of the independently rotating co-axial shafts is simplified.

The invention is described herebelow with reference to preferred embodiments which show:

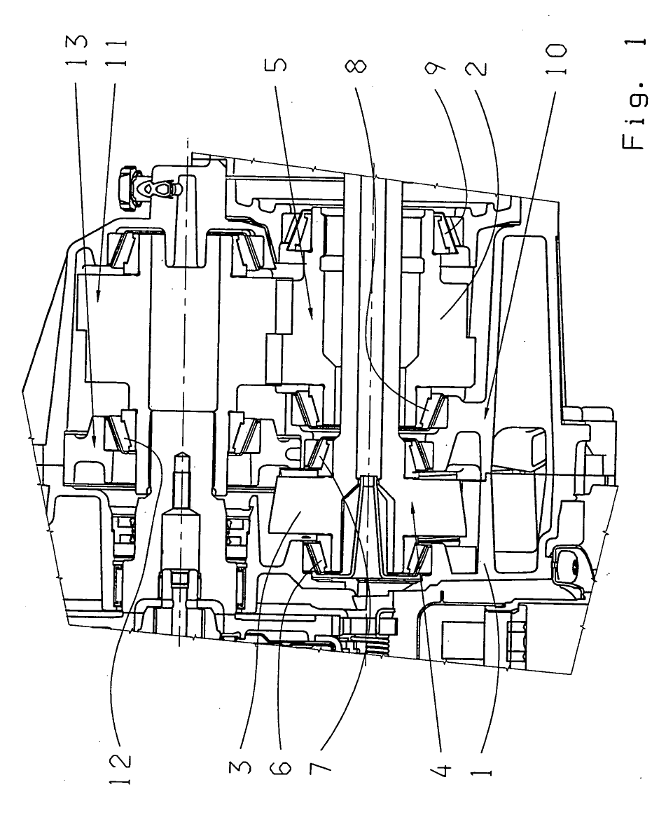

FIG. 1 is a cross-section through a bearing arrangement in a gearbox housing;

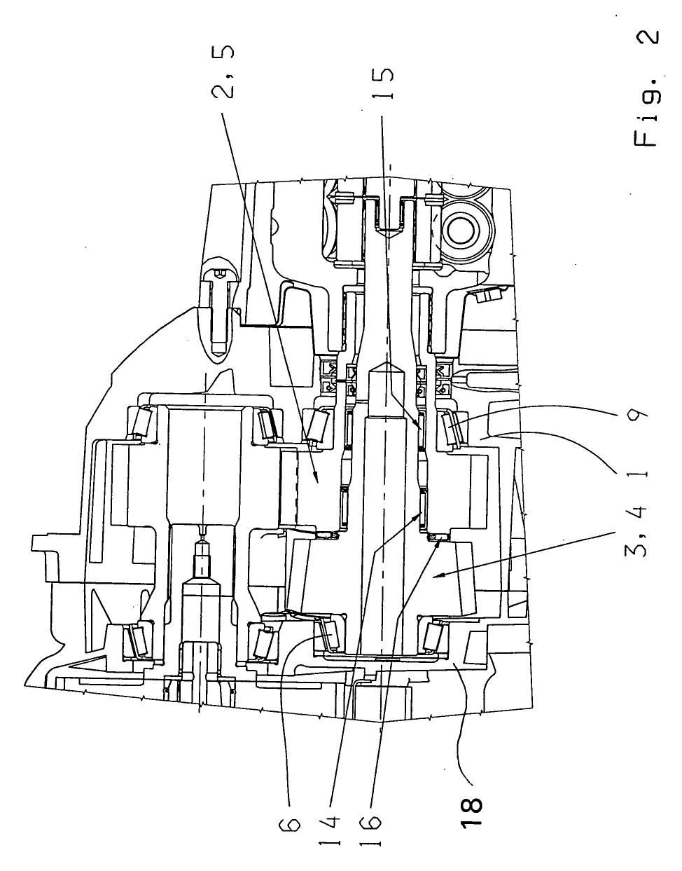

FIG. 2 is a cross-section through an inventive bearing arrangement;

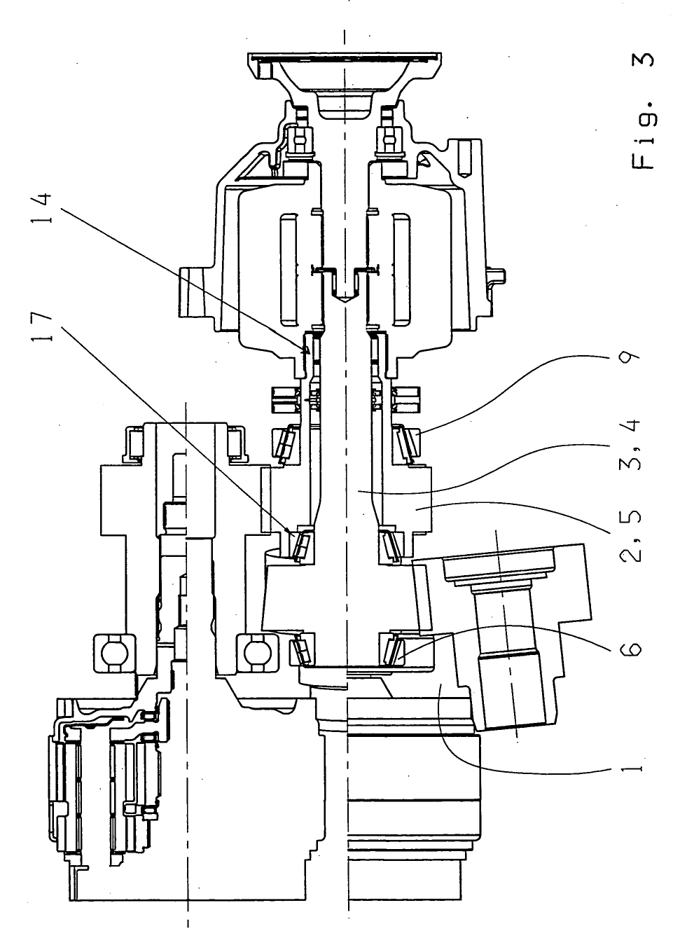

FIG. 3 is a cross-section through an alternative inventive bearing arrangement; and

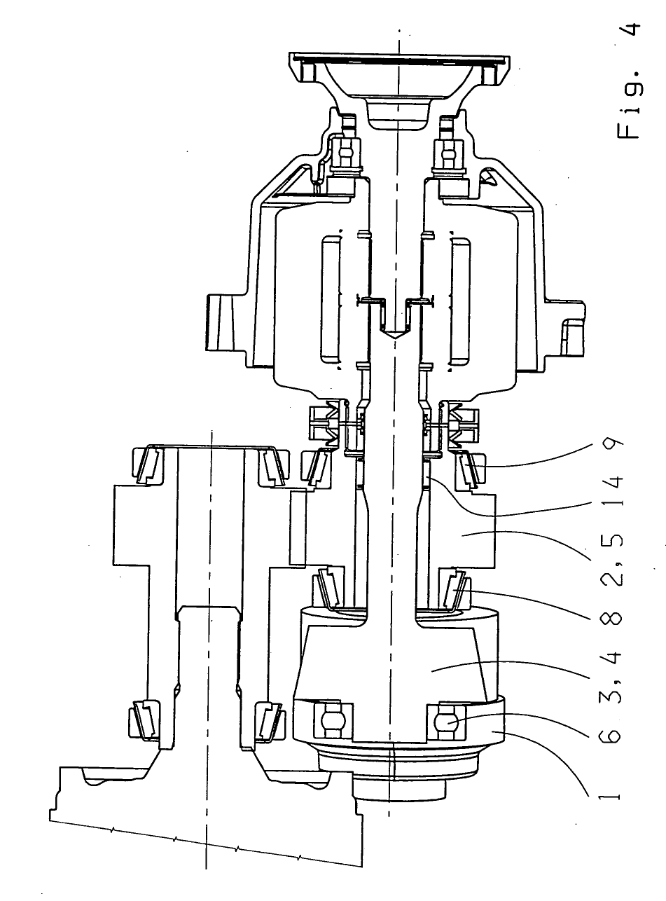

FIG. 4 is a cross-section through another alternative inventive bearing arrangement.

In a gearbox housing, two successively disposed wheels 2, 3 are supported on respective independently rotating co-axial shafts 4, 5 conventionally having one taper roller bearing 6, 7, 8 and 9 on each of both ends, which is also supported by one intermediate wall 10 in the gearbox housing 1. One adjacent shaft 11 is supported in the gearbox housing 1 with one bearing 12 on an intermediate ring 13.

FIG. 2:

Corresponding features are designated with the reference numerals of FIG. 1. The two successively disposed wheel 2, 3 are held on independently rotating co-axial shafts 4, 5, respectively, having one of the bearings 6 and 9 on the outer ends of which bearing 6 is held on a spur gear drive cover 18 mounted on the gearbox housing 1 and bearing 9 in the gearbox housing 1 and bearing 9 in the gearbox housing 1. Shaft 5 is supported on shaft 4 with radial bearings 14, 15 and one axial bearing 16.

Bearing 6 and/or bearing 9 can be designed as ball or taper roller bearings, it being possible to omit the axial bearing 16 when the bearing arrangement is designed with ball bearings 6 and 9 and then the ball bearings 6 and 9 with the radial bearings 14, 15 support the respective independently rotating co-axial shafts 4, 5.

FIG. 3:

Corresponding features are designated with the reference numerals of FIGS. 1 and 2. In the gearbox housing 1, the two successively disposed wheels 2, 3 are held on respective independently rotating co-axial shafts 4, 5 each having one of the bearings 6 and 9 on the outer ends held in the gearbox housing 1. Shaft 5 is supported with radial bearing 14 and one ball bearing 17 for axial and radial forces on the shaft 4.

FIG. 4:

Corresponding features are designated with the reference numerals of FIGS. 1, 2 and 3. In the gearbox housing 1, the two successively disposed wheels 2, 3 are held upon the respective independently rotating co-axial shafts 4, 5 which have each on the respective outer ends one of the bearings 6 and 9 held in the gearbox housing 1. Bearing 6 is designed as a ball bearing. Shaft 5 is supported on the shaft 4 with radial bearing 14 and on the gearbox housing 1 with the taper roller bearing 9 for axial and radial forces.

1-6. (canceled)

7. A bearing arrangement in a gearbox housing (1) having at least two successively disposed wheels (2, 3) supported on respective independently rotating co-axial shafts (4, 5) where one shaft (4) has on one end and the other shaft (5) on an opposite end, bearings (6, 9) supported in the gearbox housing (1) and at least one additional bearing, which can absorb both radial and axial forces, is provided between the one and the other shaft (4, 5).

8. The bearing arrangement according to claim 7, wherein the additional bearing, between the one and the other shaft (4, 5), comprises a radial bearing designed as one of a cylinder roller, a ball bearing or a needle bearing.

9. The bearing arrangement according to claim 7, wherein the additional bearing, between the one and the other shaft (4, 5), comprises one other radial bearing (14, 15) and one other axial bearing (16).

10. The bearing arrangement according to claim 7, wherein the additional bearing bearing, between the one and the other shaft (4, 5), comprises one of a ball bearing and a taper roller bearing (17).

11. The bearing arrangement according to claim 7, wherein the gearbox housing (1) comprises one adjustably mounted spur gear drive cover (18) and a first end bearing (6) is mounted in the spur gear drive cover (18) and a second end bearing (9) is mounted in the gearbox housing (1).

12. A bearing arrangement in a gearbox housing (1), the bearing arrangement comprising; a first and a second successively disposed wheels (2, 3), the first wheel (2) supported on a first rotating shaft (4), the second wheel (3) supported on a second rotating shaft (5), the first shaft (4) and the second shaft (5) independently rotate about a single axis, a first end of the first shaft (4) being supported by a first bearing (6) at a first end of the axis within the housing (1) and a first end of the second shaft (5) being supported by a second bearing (9) at an opposing second end of the axis within the housing (1), a second end of the first shaft (4) being supported within a second end of the second shaft (5) by at least one additional bearing, and the at least one additional bearing absorbing both radial and axial forces of the first and the second shafts (4, 5).
